(19) United States
(12) Patent Application Publication
(10) Pub. No.: US 2009/0164518 A1
(43) Pub. Date: Jun. 25, 2009

(54) Avatars in a virtual world

(76) Inventor: Gameelah Ghafoor, Broughty Ferry (GB)

Correspondence Address: MICHAEL CHAN;NCR CORPORATION, 1700 SOUTH PATTERSON BLVD, DAYTON, OH, 45479-0001, US

(21) Appl. No.: 12/004,353

(22) Filed: Dec. 20, 2007

(51) Int. Cl. G06F 7/00; G06F 17/30

(52) U.S. Cl. 707/104.1; 707/E17.009

(57) ABSTRACT

Methods and systems for proving improved avatars in a virtual world are described. Real life transaction data is parsed to identify transactions which relate to users of a virtual world and then details of identified transactions are mapped to attributes in the virtual world. This enables the avatar or environment associated with a user in a virtual world to be updated based on transactional events which occur in the real world.

### TECHNICAL FIELD

The present invention relates to updating attributes of a computer representation of a user. It is particularly related to, but in no way limited to, modification of an avatar in a virtual world based on financial transactions which have been made by the owner of that avatar in the real world.

### BACKGROUND

Interacting with others within a virtual world is becoming increasingly popular and there are a number of virtual worlds which users can inhabit, including Second Life, There and Active Worlds. A virtual world is a computer-based simulated environment which provides a graphical rich social environment. Users inhabit such a world and interact with others using their avatars (which are computer representations of users). Initially users may have a standard avatar and they may be able to subsequently modify the avatar to more closely resemble them.

Within the virtual world, users may be able to purchase items, such as trainers, computers, houses etc, and multinational corporations have set up shops within the virtual worlds to enable users to purchase the virtual items of well-known brands of clothing or other objects.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Methods and systems for providing improved avatars in a virtual world are described. Real life transaction data is parsed to identify transactions which relate to users of a virtual world and then details of identified transactions are mapped to attributes in the virtual world. This enables the avatar or environment associated with a user in a virtual world to be updated based on transactional events which occur in the real world.

A first aspect provides a method comprising: parsing real life transaction data; matching a transaction within the real life transaction data to a user having a computer representation; and mapping the transaction to attributes associated with the computer representation of the user.

Matching a transaction within the real life transaction data to a user having a computer representation may comprise: matching the transaction within the real life transaction data to a user of a virtual world, and mapping the transaction to attributes associated with the computer representation of the user may comprise: mapping the transaction to attributes associated user in the virtual world.

The real life transaction data may be stored in a database associated with one of a retailer, a financial institution and a payment system.

The method may further comprise: providing the user with a menu for updating or confirming the mapping.

The method may further comprise: rendering a computer representation of at least one of the user and an environment associated with the user according to the attributes.

A second aspect provides a computer program comprising computer program code means adapted to perform all the steps of any of the methods described above when said program is run on a computer.

The computer program may be embodied on a tangible computer readable medium.

A third aspect provides a system comprising: a database comprising data on a plurality of transactions in the real world; a virtual world; and a software agent, wherein the software agent is arranged to: access data on a transaction from the database; determine if the transaction relates to a user in the virtual world; and if the transaction does relate to a user in the virtual world, to map details of the transaction to attributes associated with the user in the virtual world.

The database may be operated by one of a financial institution, a retailer and a payment system.

One of the software agent and the virtual world may be arranged to: receive a subscription request from the one of a financial institution, a retailer and a payment system.

One of the software agent and the virtual world may be arranged to: receive a subscription request from a user in the virtual world, and wherein the software agent may be arranged to map details of the transaction to attributes associated with the user in the virtual world if the transaction relates to a user in the virtual world and if the agent has received a subscription request from the user.

The virtual world may be arranged to: render an avatar associated with the user and an environment associated with the user based on the attributes associated with the user in the virtual world.

A fourth aspects provides one or more tangible device-readable media with device-executable instructions for performing steps comprising: parsing real life transaction data; matching a transaction within the real life transaction data to a user having a computer representation; and mapping the transaction to attributes associated with the computer representation of the user.

Matching a transaction within the real life transaction data to a user having a computer representation may comprise: matching the transaction within the real life transaction data to a user of a virtual world, and mapping the transaction to attributes associated with the computer representation of the user may comprise: mapping the transaction to attributes associated user in the virtual world.

Many of the attendant features will be more readily appreciated as the same becomes better understood by reference to the following detailed description considered in connection with the accompanying drawings. The preferred features may be combined as appropriate, as would be apparent to a skilled person, and may be combined with any of the aspects of the invention. The term ‘agent’ is intended to include a software program, or software module/component or software unit which performs the tasks described. It does not necessarily have to be independent of a larger executable. Also, the agent and the database can be distributed over a number of computers. The agent behaviour could be distributed and designed to follow a client/server or peer-to-peer architecture instead of being knitted into one binary on one computer as in the example herein.”

### BRIEF DESCRIPTION OF THE DRAWINGS

Embodiments of the invention will be described, by way of example, with reference to the following drawings, in which:

FIG. 1 shows a flow diagram of a method of mapping real world events into a virtual world;

FIG. 2 shows a schematic diagram of system in which the method of FIG. 1 may be implemented; and

FIG. 3 shows a flow diagram of a second method of mapping real world events into a virtual world.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved.

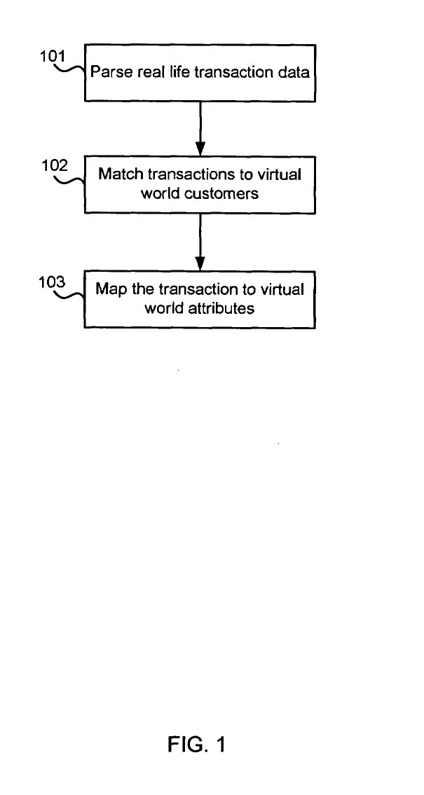

FIG. 1 shows a flow diagram of a method of mapping real world events into a virtual world so that an avatar in the virtual world and/or the belongings of the avatar, more closely resemble the real world. This process may involve user interaction (as described in more detail below) or may occur automatically so that the effort required by a user to create a representative avatar is reduced.

According to the method of FIG. 1, real life transaction data is parsed (block 101) and transactions mapped to customers of a virtual world (block 102). This real life transaction data may, for example, be credit card transactions, store card transactions, transactions for a particular retailer, transactions where a particular loyalty (or similar) card was used etc. Having identified a transaction made by a customer in a virtual world (in blocks 101 and 102), the transaction is analysed and mapped to attributes in the virtual world (block 103).

The transaction may relate to goods or services. Where the transactions relate to goods, the mapping process (in block 103) may identify the closest corresponding item in the virtual world. For example, if a virtual world user purchases an actual pair of designer jeans in a real world store using a credit card, this transaction information may be analysed and identified and then the transaction details may be mapped to the closest equivalent to the designer jeans in the virtual world. In some cases, the same goods may be available in both the real and virtual worlds and therefore there may be a direct correlation in the mapping, whilst in other cases, there may not be an exact equivalent item in the virtual world and the mapping will identify the closest available match based on a number of identified criteria (e.g. using a goods classification system). A set of common characteristics may be used as the identified criteria.

Where the transactions relate to services, the mapping process (in block 103) may map the particular service to an effect on the customer as represented by an avatar. For example, a virtual world user may pay for a hair cut in the real world and this may be mapped to a different, shorter hairstyle for the user's avatar in the virtual world. In another example, a virtual world user may pay for a paintball session in the real world and this may be mapped to a dishevelled appearance of the user's avatar or may result in the avatar being displayed with splashes of paint on their clothes. Where the mapping relates to a particular service, the service in the real world may be mapped to one of a defined set of services in the virtual world and each of these services in the set may have an associated resultant effect on an avatar or their environment (e.g. service=hair cut, effect=shorter style hair or service=paintball, effect =paint splatters). The real world service may be mapped to a virtual world service using a number of identified criteria (in a corresponding manner to the mapping of goods, described above).

The parsing of the transaction data (block 101) may be performed in a quasi-continuous manner such that there is only a small time lag between the real world transaction and the parsing of the transaction data. Alternatively, the data may be parsed periodically, e.g. once a month when a credit/store card bill or bank statement is issued. Transactions may be parsed individually or alternatively batches of data may be parsed together.

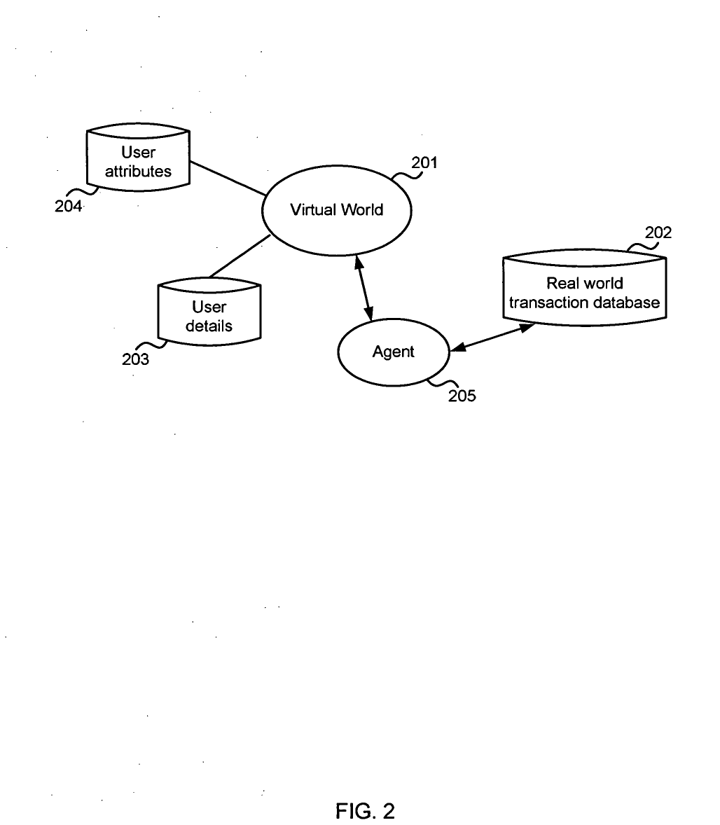

FIG. 2 shows a schematic diagram of system in which the method described above may be implemented. The system comprises a virtual world 201 (such as Second Life) and a database of real world transactions 202. The virtual world 201 may have various databases associated with it, such as a database of user details 203 and a database of user attributes 204. An agent 205 acts as an intermediary between the transaction data 202 and the virtual world 201 and may access the databases 203, 204 associated with the virtual world directly or via the virtual world application itself. The agent 205 may operate within the virtual world or within the financial institution/retailer that has the transaction data 202 or may operate independently.

Whilst in FIG. 2, the elements are shown linked by double ended arrows, the communication and transfer of data between elements may be unidirectional (in either direction) or bidirectional.

As described above, the real world transaction database may be associated with a particular financial institution (e.g. a bank, building society, store/credit card company or payment system, such as VISA or Paypal) or with a particular retailer. This database may include data on people and the transactions that they have made, e.g. Mr J Smith, designer trainers, Nov. 23, 2007. This database may include all financial transactions for all customers of the particular financial institution, retailer or other entity which runs the database. Alternatively, users may sign up (or subscribe) to the service which is provided by the methods described herein and the database may only include details of those users which have subscribed. In the situation where the users subscribe to the service, the matching of transactions to virtual world customers may still be required because the transactions may be identified by the name of an account or card holder or by an account or card number and not by the username of the user in the particular virtual world.

In another example, the real world transaction database may be provided by a third party which provides a card to users that subscribe to the service. This card may be similar to a loyalty card (which is typically distributed by a store or a group of stores, such as those stores in a particular retail park or shopping mall) and may be presented by holders of the card when transactions take place. If this card is used, the transaction details may be stored in the database and may, in some cases, automatically be associated with the virtual world customers and in particular their usernames in the virtual world. In such a scenario, the step of matching transactions to virtual world customers may be performed prior to parsing the real life transaction data because it may be performed at the point that the transaction data is entered into the database. Where such a specific card is provided, specific information may be logged in relation to the transaction which may provide more information about the goods/services purchased than would standardly be logged for the purposes of financial tracking (e.g. for processing of a credit card bill). In an example, the card may cause details of the exact goods/services to be stored in database, e.g. the model, colour etc of any goods and the nature of any services. Where available, images of the goods (or links to images of the goods) may also be stored (e.g. links to images on a web site).

The software agent 205 may perform some or all of the method steps shown in FIG. 1 and described above. In some examples, some of the steps of FIG. 1 may instead be performed within the virtual world. For example, the agent may parse the real life transaction data (block 101) and match transactions to virtual world customers (block 102). This information (i.e. details of the virtual world customer and their real world transaction) may be provided to the virtual world 201 which may perform the mapping (block 103).

In an example, the real world transaction database 202 may be located within the central payment house for a retailer and the agent may run within the retailer's network. Only the details required to perform the mapping (block 103) or the mapped virtual world attributes (output from block 103) may be provided to the virtual world 201. By performing the parsing of the transaction data within the organisation that is responsible for the data, the security of the data may be guaranteed.

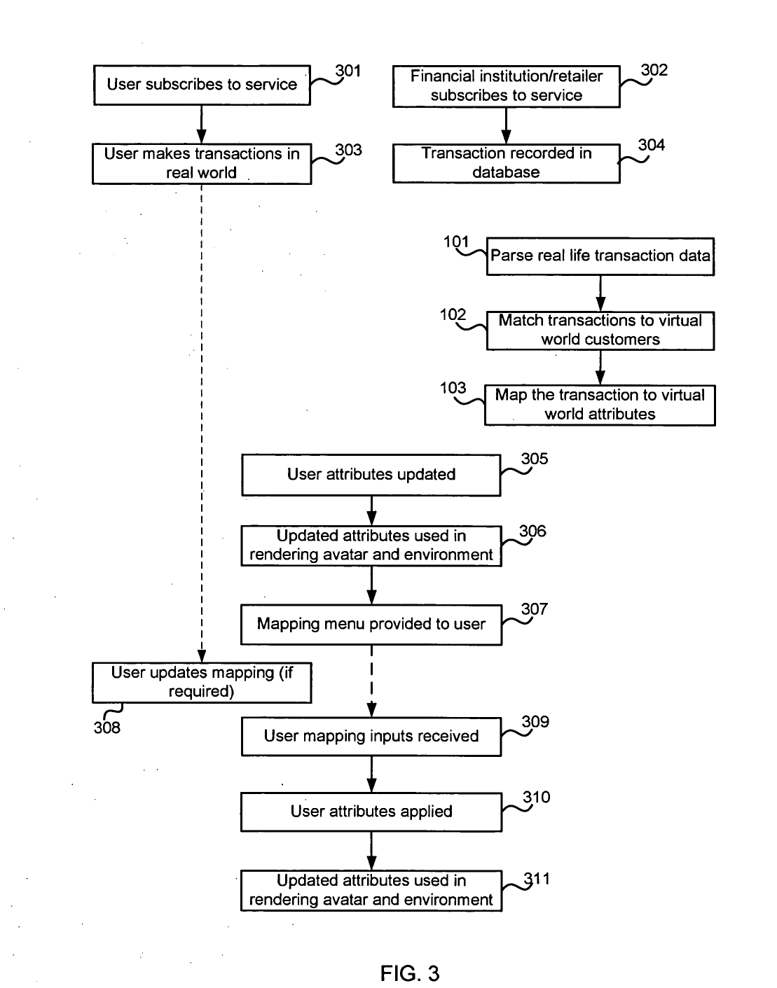

FIG. 3 shows a more detailed flow diagram of a method of mapping real world events into a virtual world. As shown in this example, the user may subscribe to the service (block 301) and financial institutions/retailers or other entities may also subscribe to the service (block 302). Where a user subscribes to this service, they may be able to specify which types of transactions are mapped (e.g. services/goods, types of goods etc) using the methods described herein or all transactions may be analysed and mapped if appropriate. Financial institutions/retailers may subscribe to this service such that they provide the agent with means to access data from their transaction database, or they may provide transaction data to a database operated by a third party (which may be the operator of the software agent). In some scenarios, the subscription by a financial institution/retailer may result in them having their own agent which runs internally on their own database of transactions.

When a user makes a transaction in the real world (block 303), data relating to this transaction is stored in a database (block 304). This database may be a standard database used by the retailer/financial institution for other purposes or may be a custom database for use with virtual worlds, as described herein. Periodically or in a substantially continuous manner, the real life transaction data may be parsed (block 101), matched to virtual world customers (block 102) and the transaction details mapped to attributes in the virtual world (block 103).

User attributes in the virtual world may be updated (block 305) based on the mapped attributes (generated in block 103). These updated attributes may, for example, be stored in a database of user attributes 204 (as shown in FIG. 2). These updated attributes may then be used in the virtual world when rendering a user's avatar and/or environment (block 306). For example, where the transaction relates to the purchase of a particular make and style of trainers, the attributes may be updated to record that the user's character in the virtual world owns such a pair of trainers and the avatar may be shown wearing the trainers. In another example, where the transaction relates to the purchase of some flowers, the attributes may be updated such that when the avatar's home is rendered within the virtual world, there is a vase of flowers on display.

In some examples, the mapping may be without user input; however in other examples, the user may be provided with a graphical user interface (GUI) by which they can influence the mapping or can adjust updated attributes once they have been mapped using an automatic process. In the example shown in FIG. 3, a mapping menu is provided to the user (block 307) which enables them to confirm the mapping, adjust the mapping etc (block 308). For example, where a user purchases a particular item of clothing it may come in several different colours and this specific information may not be obtainable from the raw transaction data. The mapping menu may, therefore, provide the user with the option to change the colour of the item of clothing which has been mapped from the real world transaction into the virtual world. In another example, where there is no direct mapping between a real world item and a virtual world item, the user may be provided with a number of items which are considered to be similar to that purchased in the real world (e.g. in a manner analogous to shopping web sites which present similar items) so that the user can select one. The user may also be asked to confirm whether any mapping should occur for a particular transaction.

In another example, the GUI may provide the user with a list of recent transactions in the real world (in an analogous manner to an online credit card bill) and the user may be able to select which transactions should be mapped to the virtual world. In another example, this functionality may be integrated with a financial service, such that the mapping options are provided alongside viewing a credit/store card online. Where the transactions relate to an online payment system (such as Paypal), a check box may be provided when the transaction is performed to enable the user to indicate whether a particular transaction should be mapped into the virtual world or not. Where a user participates in multiple virtual worlds, the user may also be able to specify which virtual worlds the transaction should be mapped into.

On receipt of user input (block 309), the user attributes may be updated (block 310) and these updated attributes may then be used in the virtual world when rendering a user's avatar and/or environment (block 311).

Different steps of the method shown in FIG. 3 may be performed by different entities. In a first example, the user may subscribe to the service (block 301) through the virtual world, through a service provided by the agent (e.g. a web service) or direct with a particular financial institution or retailer. The subscription by the financial institution or retailer itself (block 302) may be performed through a service provided by the agent or directly with the virtual world. As described above, the recording of transactions in a database (block 304) may be performed by the retailer or financial institution or alternatively by a third party (which may be the software agent). The parsing of the transaction data (block 101) may be performed by the software agent or by the retailer/financial institution and the matching of the transactions to virtual world customers (block 102) may be performed by the agent or by the virtual world itself. The mapping of the transaction to virtual world attributes (block 103) may again be performed by the agent or the virtual world. The updating of the user attributes (block 305) may also be performed by the agent or the virtual world. The rendering step (block 306) is most likely to be performed by the virtual world. The GUI that enables the user to update or amend the mapping process (blocks 307 and 309, if this functionality is provided) is likely to be provided by the virtual world, although the agent may perform this instead. The updating of the user attributes (block 310) may be performed by the same entity that previously updated the attributes (in block 305) or by another entity and as before, the rendering step (block 311) is most likely to be performed by the virtual world.

The service described above in which real world transactions are mapped to changes in attributes in a virtual world may be provided free of charge to either or both a virtual world user and a retailer/financial institution or alternatively there may be a charge associated with the service. For example, a user may be required to pay a premium for those purchases that they wish to be mapped into the virtual world, e.g. 1% or 0.5% in addition to the standard purchase price. In another example, a retailer may be asked to pay to provide this functionality to customers (e.g. $0.01 per transaction) as the benefit to the retailer is that they gain additional advertising in the virtual world (e.g. by many avatars wearing their products). This service may also provide a differentiator to retailers/service providers/financial institutions. In further examples, charges may be levied on both the retailer/service provider/financial institution and the user.

In a further example, a user may be prompted following a transaction to decide whether they wish the transaction to be mapped into the virtual world. This prompt may be provided at the point of sale or subsequently (e.g. in an email or when they next log in to the virtual world). In this example, a user may select which transactions should be mapped and which should not be and this may be particularly applicable where there is a charge to the user for the mapping service (as described above). This prompt which is provided may be a prompt to perform the mapping and/or may result in the user making a corresponding transaction in the virtual world, which may be paid for in real/virtual currency. Where the prompt results in performing a corresponding transaction in the virtual world, the cost may not be a fixed amount or percentage but may alternatively be an amount set within the virtual world by the retailer or service provider.

In a further variation of the financial model which may be applied to the methods described herein, the users within the virtual world may be provided with an incentive to map their transactions into the virtual world. These incentives may be provided by the particular retailers (e.g. retailers of particular high profile goods) to encourage users to display the goods in the virtual world and thereby raise the profile and public awareness of the retailer. The incentive may be monetary (in terms of virtual/real world currency) or be through a points or rewards scheme.

Whilst the above description refers to the modification of avatars in a virtual world, in other examples, it may be other user representations which are modified, such as the representations which are used in instant messaging, games or chat applications, or representations which are displayed on social networking web sites, such as Facebook.

The methods described above provide the synergy between activities by a user in the real world and the user's avatar which represents them in a virtual world or in another computing environment.

Any range or device value given herein may be extended or altered without losing the effect sought, as will be apparent to the skilled person. It will be understood that the benefits and advantages described above may relate to one embodiment or may relate to several embodiments. It will further be understood that reference to ‘an’ item refer to one or more of those items.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

The methods described herein may be performed by software in machine readable form on a tangible storage medium. The software can be suitable for execution on a parallel processor or a serial processor such that the method steps may be carried out in any suitable order, or simultaneously. This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

What is claimed is:

1. A method comprising:
parsing real life transaction data;
matching a transaction within the real life transaction data to a user having a computer representation; and
mapping the transaction to attributes associated with the computer representation of the user.

2. A method according to claim 1, wherein matching a transaction within the real life transaction data to a user having a computer representation comprises:
matching the transaction within the real life transaction data to a user of a virtual world,
and wherein mapping the transaction to attributes associated with the computer representation of the user comprises:
mapping the transaction to attributes associated user in the virtual world.

3. A method according to claim 1, wherein the real life transaction data is stored in a database associated with one of a retailer, a financial institution and a payment system.

4. A method according to claim 1, further comprising:
providing the user with a menu for updating or confirming the mapping.

5. A method according to claim 1, further comprising:
rendering a computer representation of at least one of the user and an environment associated with the user according to the attributes.

6. A system comprising:
a database comprising data on a plurality of transactions in the real world; a virtual world; and
a software agent,
wherein the software agent is arranged to:
access data on a transaction from the database;
determine if the transaction relates to a user in the virtual world; and
if the transaction does relate to a user in the virtual world, to map details of the transaction to attributes associated with the user in the virtual world.

7. A system according to claim 6, wherein the database is operated by one of a financial institution, a retailer and a payment system.

8. A system according to claim 7, wherein one of the software agent and the virtual world are arranged to:
receive a subscription request from the one of a financial institution, a retailer and a payment system.

9. A system according to claim 6, wherein one of the software agent and the virtual world are arranged to:
receive a subscription request from a user in the virtual world,
and wherein the software agent is arranged to map details of the transaction to attributes associated with the user in the virtual world if the transaction relates to a user in the virtual world and if the agent has received a subscription request from the user.

10. A system according to claim 6, wherein the virtual world is arranged to:
render an avatar associated with the user and an environment associated with the user based on the attributes associated with the user in the virtual world.

11. One or more tangible device-readable media with device-executable instructions for performing steps comprising:
parsing real life transaction data;
matching a transaction within the real life transaction data to a user having a computer representation; and
mapping the transaction to attributes associated with the computer representation of the user.

12. One or more tangible device-readable media with device-executable instructions according to claim 11, wherein matching a transaction within the real life transaction data to a user having a computer representation comprises:
matching the transaction within the real life transaction data to a user of a virtual world,
and wherein mapping the transaction to attributes associated with the computer representation of the user comprises:
mapping the transaction to attributes associated user in the virtual world.
